(19) United States
(12) Patent Application Publication
(10) Pub. No.: US 2024/0406630 A1
(43) Pub. Date: Dec. 5, 2024

(54) AUDIO SYSTEM ARRANGED IN A LISTENING ENVIRONMENT

(71) Applicant: Harman Becker Automotive Systems GmbH, Karlsbad (DE)

(72) Inventor: Christopher LEE, Karlsbad (DE)

(73) Assignee: Harman Becker Automotive Systems GmbH, Karlsbad (DE)

(21) Appl. No.: 18/677,403

(22) Filed: May 29, 2024

(30) Foreign Application Priority Data
May 30, 2023 (EP) 23 176 119.8

(51) Int. Cl. H04R 5/02; H04R 5/04

(52) U.S. Cl. CPC H04R 5/02; H04R 5/04; H04R 2205/024; H04R 2499/13

(57) ABSTRACT

An audio system arranged in a listening environment in a vehicle. The vehicle comprises at least one first passenger seat or row of seats facing in a first direction, at least one second passenger seat or row of seats facing in a second direction opposite the first direction. The audio system comprises a first multi-beam loudspeaker array configured to generate at least a first main beam and a second main beam, and a second multi-beam loudspeaker array configured to generate at least a third main beam and a fourth main beam. The audio system is configured to direct the first main beam towards the at least one second passenger seat or row of seats and provide first audio content to the at least one second passenger seat or row of seats, direct the second main beam towards the at least one first passenger seat or row of seats.

### CROSS-REFERENCE TO RELATED APPLICATIONS

This application claims priority to EP application Ser. No. 23/176,119.8 filed May 30, 2023, the disclosure of which is hereby incorporated in its entirety by reference herein.

### TECHNICAL FIELD

The disclosure relates to an audio system arranged in a listening environment, in particular, a listening environment in a vehicle comprising opposite facing seats.

### BACKGROUND

Integration of speakers in a vehicle may be challenging. When integrating a speaker into a vehicle, many different aspects and constraints have to be considered. Each passenger of the vehicle should have a similarly satisfying listening experience. Additional challenges arise for vehicles comprising passenger seats or rows facing in opposite directions.

There is a need for an audio system arranged in a listening environment in a vehicle comprising passenger seats or rows of seats facing in opposite directions that provides a satisfying listening experience for all occupants that are present in the listening environment.

### SUMMARY

An audio system arranged in a listening environment in a vehicle is disclosed herein. The vehicle includes at least one first passenger seat or row of seats facing in a first direction, and at least one second passenger seat or row of seats facing in a second direction opposite the first direction. The audio system includes a first multi-beam loudspeaker array configured to generate at least a first main beam and a second main beam, and a second multi-beam loudspeaker array configured to generate at least a third main beam and a fourth main beam. The audio system is configured to direct the first main beam towards the at least one second passenger seat or row of seats and provide first audio content to the at least one second passenger seat or row of seats, direct the second main beam towards the at least one first passenger seat or row of seats and provide second audio content that is different from the first audio content to the at least one first passenger seat or row of seats, direct the third main beam towards the at least one first passenger seat or row of seats and provide the first audio content to the at least one first passenger seat or row of seats, and direct the fourth main beam towards the at least one second passenger seat or row of seats and provide the second audio content to the at least one second passenger seat or row of seats.

Other systems, features and advantages of the disclosure will be or will become apparent to one with skill in the art upon examination of the following detailed description and figures. It is intended that all such additional systems, methods, features and advantages included within this description, be within the scope of the invention and be protected by the following claims.

### BRIEF DESCRIPTION OF THE DRAWINGS

The arrangements may be better understood with reference to the following description and drawings. The components in the figures are not necessarily to scale, emphasis instead being placed upon illustrating the principles of the invention. Moreover, in the figures, like referenced numerals designate corresponding parts throughout the different views.

FIG. 1 schematically illustrates a top view of an audio system arranged in a listening environment in a vehicle according to embodiments of the disclosure.

FIG. 2 schematically illustrates an audio system according to embodiments of the disclosure.

FIG. 3 illustrates an example system block diagram of beamforming filters and rotation matrix for a multi-beam loudspeaker array.

FIG. 4 schematically illustrates a top view of another audio system arranged in a listening environment in a vehicle according to embodiments of the disclosure.

FIG. 5 schematically illustrates a top view of an even further audio system arranged in a listening environment in a vehicle according to embodiments of the disclosure.

FIG. 6 schematically illustrates a multi-beam loudspeaker array according to embodiments of the disclosure.

FIG. 7 schematically illustrates a top view of an even further audio system arranged in a listening environment in a vehicle according to embodiments of the disclosure.

### DETAILED DESCRIPTION

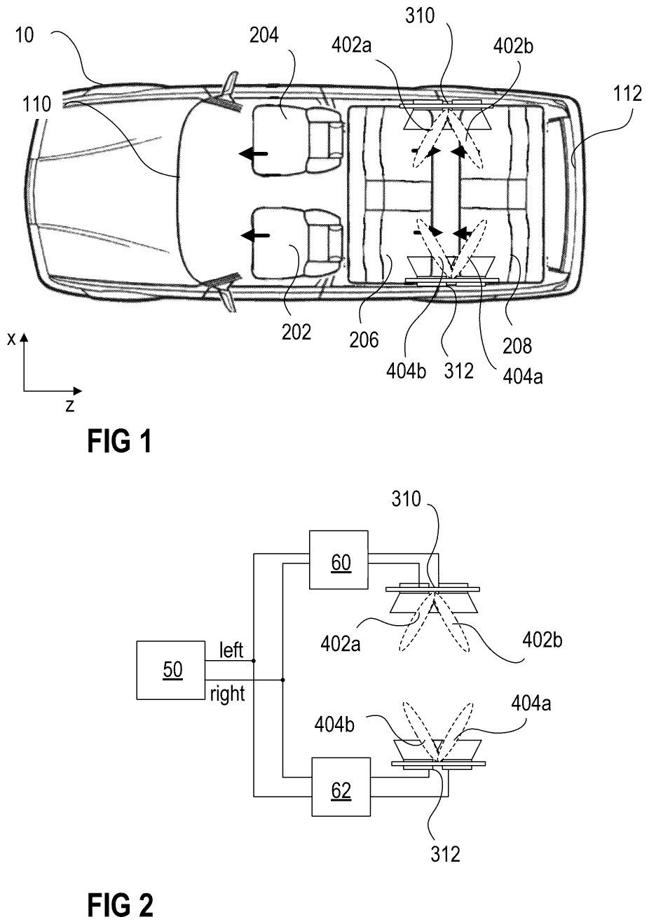

FIG. 1 schematically illustrates a top view of a vehicle 10. The vehicle 10 comprises a first car seat 202 (e.g., a driver's seat) and a second car seat 204 (e.g., a front passenger's seat). Most vehicles comprise one or in some cases also two additional rows of seats arranged behind the first and second car seats 202, 204. In most vehicles, all seats face in the same direction (i.e., the direction of travel). Some vehicles, however, comprise one seat or an additional row of seats that faces in an opposite direction. Such a vehicle 10 is schematically illustrated in FIG. 1. In the vehicle cabin, a first passenger seat or row of seats 208 (two seats are schematically illustrated in FIG. 1) faces in a first direction (i.e. the direction of travel, or towards a windshield 110 of the vehicle 10), and a second passenger seat or row of seats 206 (two seats are schematically illustrated in FIG. 1) faces in a second direction opposite the first direction (i.e. towards a rear window 112 of the vehicle 10). Passengers seated on the first passenger seat or row of seats 208 may face a windshield 110 of the vehicle 10, and passengers seated on the second passenger seat or row of seats 206 may instead face a rear window 112 of the vehicle 10.

When audio is played by an audio system arranged in the listening environment in the vehicle 10, all passengers should experience a similarly satisfying listening experience. This, however, may be challenging, for example, when stereo sound or any left-right upmix derived from a stereo source or, more generally, any format/source that separates content in a left/right-plane (e.g., 5.1 or 7.1 format) is played in a vehicle with seats or rows of seats facing in opposite directions. In order to provide a satisfying listening experience to all (rear) passengers of the vehicle 10, the audio system comprises a first multi-beam loudspeaker array 310 configured to generate at least a first main beam 402a and a second main beam 402b, and a second multi-beam loudspeaker array 312 configured to generate at least a third main beam 404a and a fourth main beam 404b. The audio system is configured to direct the first main beam 402a towards the at least one second passenger seat or row of seats 206, to provide first audio content to the at least one second passenger seat or row of seats 206, to direct the second main beam 402b towards the at least one first passenger seat or row of seats 208, and to provide second audio content to the at least one first passenger seat or row of seats 208. The audio system is further configured to direct the third main beam 404a towards the at least one first passenger seat or row of seats 208, to provide the first audio content to the at least one first passenger seat or row of seats 208, to direct the fourth main beam 404b towards the at least one second passenger seat or row of seats 206 and to provide the second audio content to the at least one second passenger seat or row of seats 206.

The first audio content may be a left audio content (e.g., left channel, left stereo audio signal, or any left audio content derived from a stereo source), and the second audio content may be a right audio content that is different from the left audio content (e.g., right channel, right stereo audio signal, or any right audio content derived from a stereo source). In this way, one or more passengers seated on the at least one first passenger seat or row of seats 208 receive the right audio content from their respective right side (second main beam 402b), and the left audio content from their respective left side (third main beam 404a). The same applies for one or more passengers seated on the at least one second passenger seat or row of seats 206, who receive the right audio content from their respective right side (fourth main beam 404b), and the left audio content from their respective left side (first main beam 402a).

Each of the first multi-beam loudspeaker array 310 and the second multi-beam loudspeaker array 312 may comprise two or more loudspeakers. In the figures, each multi-beam loudspeaker array 310, 312 is illustrated comprising two loudspeakers for illustration purposed only. The directions of the main beams 402a, 402b, 404a, 404b generated by each multi-beam loudspeaker array 310, 12 may be adjusted towards the respective passenger seats or rows of seats 206, 208 via, for example, active and/or passive loudspeaker array processing techniques.

As is schematically illustrated in FIG. 1, the first multi-beam loudspeaker array 310 is arranged between the at least one first passenger seat or row of seats 208 and the at least one second passenger seat or row of seats 206 in a first horizontal direction z, and towards a first side of the first passenger seat or row of seats 208 and the at least one second passenger seat or row of seats 206 in a second horizontal direction x that is perpendicular to the first horizontal direction z. Similarly, the second multi-beam loudspeaker array 312 is arranged between the at least one first passenger seat or row of seats 208 and the at least one second passenger seat or row of seats 206 in the first horizontal direction z, and towards a second side of the first passenger seat or row of seats 208 and the at least one second passenger seat or row of seats 206 in the second horizontal direction x. In particular, the first multi-beam loudspeaker array 310 may be arranged in or mounted to a right side panel of the vehicle 10, and the second multi-beam loudspeaker array 312 may be arranged in or mounted to a left side panel of the vehicle 10.

The two or more loudspeakers of each multi-beam loudspeaker array 310, 312 may be arranged in a straight line (see, e.g., FIG. 1), or may be angled (arranged at an angle) with respect to each other, in order to direct the main beams 402a, 402b, 404a, 404b in the desired directions. That is, the radiating surfaces of two or more loudspeakers of the first multi-beam loudspeaker array 310 may not be arranged in essentially the same plane (when neglecting any curvatures of the radiating surfaces), but may be arranged, for example, on a segment of a circle instead. In other words, a plane P1, P2, P3 defined by a radiating surface of one loudspeaker may be arranged at an angle α1, α2, α3 of between 0° and 180° with respect to the planes P1, P2, P3 defined by the radiating surfaces of the other loudspeakers of the first multi-beam loudspeaker array 310. This is exemplarily illustrated in FIG. 6 for a first multi-beam loudspeaker array 310 comprising three loudspeakers. In this way, sound may be steered passively at a higher frequency towards desired directions. Each of the speakers of such a multi-beam loudspeaker array 310 will naturally beam sound at higher frequencies (very narrow directivity of a single unit). According to one example, the multi-beam loudspeaker array 310 as illustrated in FIG. 6 may be used to emit sound at low frequencies and passive beamsteering may take over at higher frequencies. For example, the very left loudspeaker as illustrated in FIG. 6 may provide the first main beam 402a, and the very right loudspeaker of the multi-beam loudspeaker array 310 of FIG. 6 may provide the second main beam 402b. Passive beamsteering may additionally be complemented by using loudspeakers within the multi-beam loudspeaker arrays comprising respective waveguides that are configured to control directivity of the emitted sound. The same applies for the loudspeakers of the second multi-beam loudspeaker array 312.

In the figures, the loudspeakers of each multi-beam loudspeaker array 310, 312 are illustrated as directly adjoining each other. That is, a distance between two neighboring loudspeakers of a multi-beam loudspeaker array 310, 312 may be, for example, zero. It is generally possible that neighboring loudspeakers of a multi-beam loudspeaker array are arranged distant from each other. However, according to one example, a distance between two neighboring loudspeakers may be less than a maximum distance. For example, the radiating surfaces (loudspeaker membranes) of the loudspeakers of the first multi-beam loudspeaker array 310 may have identical diameters, and a distance between two neighboring loudspeakers of the first multi-beam loudspeaker array 310 may be less than twice the diameter of a radiating surface. Similarly, the radiating surfaces (loudspeaker membranes) of loudspeakers of the second multi-beam loudspeaker array 312 may have, for example, identical diameters, and a distance between two neighboring loudspeakers of the second multi-beam loudspeaker array 312 may be, for example, less than twice the diameter of a radiating surface.

Now referring to FIG. 2, a first multi-beam loudspeaker array 310 and a second multi-beam loudspeaker array 312 of an audio system are schematically illustrated. The audio system may further comprise an audio source 50 that is configured to output an audio input having left and right channels or a preprocessed signal based on or extracted from left and right channels. The audio system may further comprise a first loudspeaker beamformer 60. The first loudspeaker beamformer 60 may have two inputs. At a first input, the first loudspeaker beamformer 60 receives the left audio input (e.g., left channel or left processed component), and at a second input the first loudspeaker beamformer 60 receives the right audio input (e.g., right channel or right processed component). The first loudspeaker beamformer 60 is further connected to the first multi-beam loudspeaker array 310. Each of the left and right audio input corresponds to an acoustic beam 402a, 402b of defined beam width. The audio system may further comprise a second loudspeaker beamformer 62. The second loudspeaker beamformer 62 may have two inputs. At a first input, the second loudspeaker beamformer 62 receives the left audio input (e.g., left channel or left processed component), and at a second input the second loudspeaker beamformer 62 receives the right audio input (e.g., right channel or right processed component). The second loudspeaker beamformer 62 is further connected to the second multi-beam loudspeaker array 312. Each of the left and right audio input corresponds to an acoustic beam 404a, 404b of defined beam width. The directions of the different acoustic beams 402a, 402b, 404a, 404b may be adjusted individually.

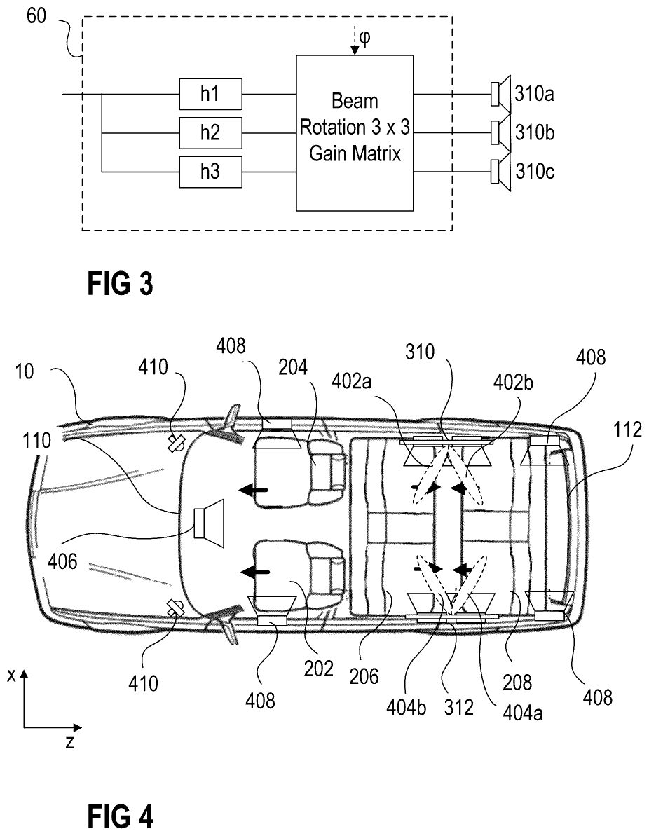

Each of the first loudspeaker beamformer 60 and the second loudspeaker beamformer 62 may comprise, for example, one or more beamforming filters and a rotation matrix. This is schematically illustrated in FIG. 3 by the first loudspeaker beamformer 60. The first loudspeaker beamformer 60 in this example includes three beamforming filters h1, h2, h3, and a rotation matrix. As shown, a first loudspeaker 310a of the first multi-beam loudspeaker array 310 is connected to a first beam forming filter h1, a second loudspeaker 310b of the first multi-beam loudspeaker array 310 is connected to a second beam forming filter h2, and a third loudspeaker 310c of the first multi-beam loudspeaker array 310 is connected to a third beam forming filter h3. Each loudspeaker of a multi-beam loudspeaker array, for example, is connected to a different one of the filters. It is generally also possible that pairs of loudspeakers (two loudspeakers) share the same filter. The beams generated by the multi-beam loudspeaker array 310 can be rotated to any desired angle by re-assigning the loudspeakers 310a, 310b, 310c to different beamforming filters h1, h2, h3. By re-assigning the loudspeakers 310a, 310b, 310c, certain rotation angles may be achieved, e.g., q=60°. Any other angles may be realized by linear interpolation of the respective loudspeaker signals. The rotation matrix in the example of FIG. 3 is realized as a 3×3 gain matrix, because there are three beamforming filters h1, h2, h3 and three loudspeakers 310a, 310b, 310c in this example. However, different numbers of filters and loudspeakers would affect the dimensions of the rotation matrix. Generally speaking, each of the first loudspeaker beamformer 60 and the second loudspeaker beamformer 62 may comprise an L x M gain matrix, wherein L is the number of beamforming filters of the respective loudspeaker beamformer 60, 62, and M is the number of loudspeakers comprised in the respective multi-beam loudspeaker array 310, 312. Generally, the following applies: L≥2, and M≥2. Besides linear interpolation, other interpolation laws such as, for example., cosine or cosine squared may additionally or alternatively be used. By setting the rotation angles of the beams 402a, 402b appropriately, the beams can be aimed at the at least one first passenger seat or row of seats 208, and the at least one second passenger seat or row of seats 206, respectively.

The beam forming filters may be or may comprise Finite Impulse Response (FIR), for example, filters, or IIR (Infinite Impulse Response) filters. However, any suitable gain and delay array techniques may also be used instead. Further, any suitable pre- or post-processing techniques may be applied to the respective signals at any point before or after the beam forming filters.

Each left/right input connects to its own set of beamforming filters and rotation matrix. That is, one or more first beamforming filters and first rotation matrix may be used for the left audio input, and one or more second beamforming filters and second rotation matrix may be used for the right audio input. Each of the multi-beam loudspeaker arrays 310, 312 may generate a left beam 402a, 404a of audio content at a first angle using a first rotation matrix, and may generate a right beam 402b, 404b of audio content at a second angle that is different from the first angle using a second rotation matrix. The outputs of the beamforming filters h1, h2, h3 may be routed to the speaker channels at the desired angle. The beams of audio content may be applied to the respective array of loudspeaker elements.

The audio system comprising the first multi-beam loudspeaker array 310, and the second multi-beam loudspeaker array 312 may be integrated in a complex audio system arranged in the vehicle 10. For example, the vehicle 10 may further comprise one or more additional loudspeakers 406, 408 such as, for example, subwoofers for bass reproduction and/or front passenger speakers. The vehicle 10 may further comprise, for example, one or more tweeters 410. A listening environment in a vehicle 10 comprising an exemplary complex audio system is schematically illustrated in FIG. 4. The first multi-beam loudspeaker array 310, the second multi-beam loudspeaker array 312, the additional loudspeakers 406, 408, and the tweeters 410 are only schematically illustrated in FIG. 4. A complex audio system of a vehicle 10 may comprise more or less than the components as illustrated in FIG. 4. Even further, the positions at which the additional components 406, 408, 410 (loudspeakers, tweeters, etc.) are arranged within the vehicle 10 are merely examples.

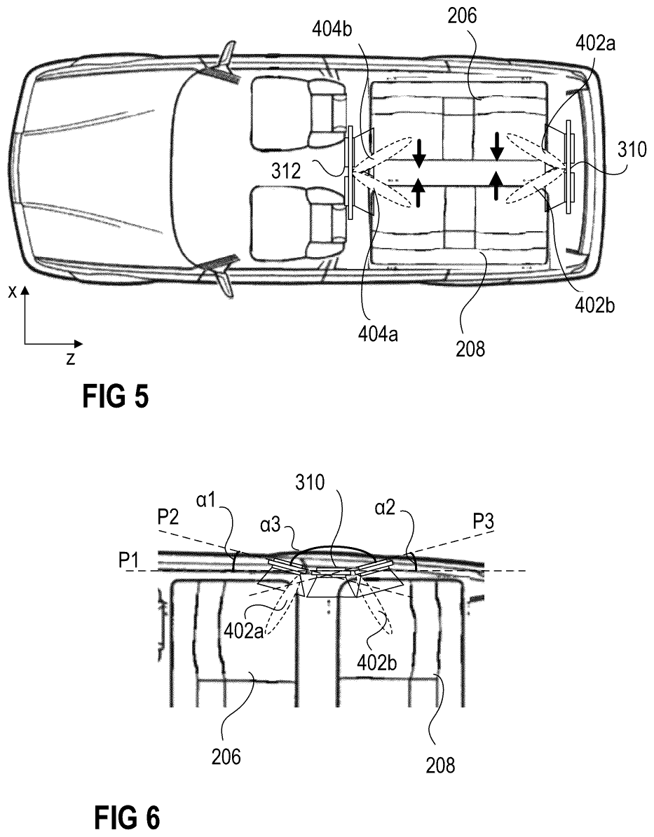

Now referring to FIG. 5, an audio system arranged in a listening environment in a vehicle 10 is schematically illustrated. In the vehicle 10, the first passenger seat or row of seats 208, and the at least one second passenger seat or row of seats 206 face sideways in opposite directions. That is, the entire arrangement as has been described with respect to FIG. 1 above is turned by 90°. The passenger seats, or rows of seats, however, also face in opposite directions and towards each other. Therefore, the same principles apply as have been described with respect to FIG. 1 above. In this example, passengers seated on the at least on first passenger seat or row of seats face towards a right-side window of the vehicle, and passengers seated on the second passenger seat or row of seats face towards a left-side window of the vehicle. The first multi-beam loudspeaker array 310 of the audio system may be arranged in or mounted to a rear panel of the vehicle 10, and the second multi-beam loudspeaker array 312 of the audio system may be arranged, for example, in or adjacent to a center console of the vehicle 10.

Summarizing the above, the different main beams 402a, 402b, 404a, 404b generated by the first and second multi-beam loudspeaker arrays 310, 312 provide different audio content such as, for example, direct stereo signals or pre-processed stereo signals (e.g., from an upmixer or 5.1 stereo signals), towards the different listening positions within the vehicle 10. Each single beam is used to provide a desired audio content (e.g., left channel or right channel of an audio input, or preprocessed signals based on or extracted from left and right channels) towards one of the different listening positions in the vehicle 10. In this way, all passengers that are present in a listening environment of a vehicle 10, even when facing in opposite directions, experience a similarly satisfying listening experience.

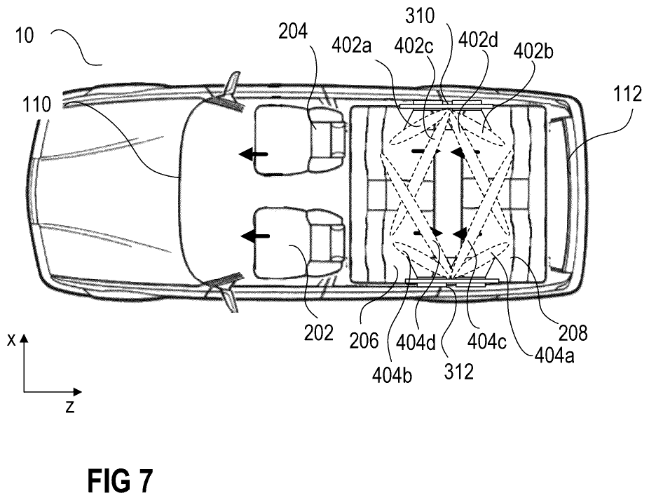

Similar to what has been described above, each of the first and second multi-beam loudspeaker array 310, 312 may generate even more than two main beams. In the examples as illustrated and described above, the first main beam 402a, for example, is directed towards both of the two seats of the second passenger row of seats 206. The same applies for the second, third, and fourth main beams 402b, 404a, 404b which are each directed to both seats of the respective row of seats. It is, however, also possible that separate main beams be generated for each seat of a row of seats 206, 208. In the example illustrated in FIG. 7, with each row comprising two seats, each multi-beam loudspeaker array 310, 312 may be configured to, for example, generate four main beams 402a, 402b, 402c, 402d, 404a, 404b, 404c, 404d, one for each of the four different seats. In the example illustrated in FIG. 7, the first multi-beam loudspeaker array 310 is configured to generate a first main beam 402a providing first audio content towards a first seat of the second row of seats 206, a second main beam 402b providing second audio content towards a first seat of the first row of seats 208, a fifth main beam 402c providing first audio content towards a second seat of the second row of seats 206, and a sixth main beam 402d providing second audio content towards a second seat of the first row of seats 208. Similarly, the second multi-beam loudspeaker array 312 is configured to generate a third main beam 404a providing first audio content towards the second seat of the first row of seats 208, a fourth main beam 404b providing second audio content towards the second seat of the second row of seats 206, a seventh main beam 404c providing first audio content towards the first seat of the first row of seats 208, and an eighth main beam 404d providing second audio content towards the first seat of the second row of seats 206. If a row of seats 206, 208 comprises more than two seats, even more than four beams may be generated by each of the first and second multi-beam loudspeaker array 310, 312.

The general concept has been described with respect to a listening environment in a passenger car above. Generally, however, the vehicle 10 may be any kind of vehicle such as, e.g., a passenger car, a van, a camper van, a caravan, a truck, a bus, a tractor, an airplane, a ship, etc. It may be understood, that the illustrated systems are merely examples. While various embodiments of the invention have been described, it will be apparent to those of ordinary skill in the art that many more embodiments and implementations are possible within the scope of the invention. In particular, the skilled person will recognize the interchangeability of various features from different embodiments. Although these techniques and systems have been disclosed in the context of certain embodiments and examples, it will be understood that these techniques and systems may be extended beyond the specifically disclosed embodiments to other embodiments and/or uses and obvious modifications thereof. Accordingly, the invention is not to be restricted except in light of the attached claims and their equivalents.

The description of embodiments has been presented for purposes of illustration and description. Suitable modifications and variations to the embodiments may be performed in light of the above description or may be acquired from practicing the methods. The described arrangements are exemplary in nature, and may include additional elements and/or omit elements. As used in this application, an element recited in the singular and proceeded with the word “a” or “an” should be understood as not excluding plural of said elements, unless such exclusion is stated. Furthermore, references to “one embodiment” or “one example” of the present disclosure are not intended to be interpreted as excluding the existence of additional embodiments that also incorporate the recited features. The terms “first,” “second,” and “third,” etc. are used merely as labels, and are not intended to impose numerical requirements or a particular positional order on their objects. The described systems are exemplary in nature, and may include additional elements and/or omit elements. The subject matter of the present disclosure includes all novel and non-obvious combinations and sub-combinations of the various systems and configurations, and other features, functions, and/or properties disclosed. The following claims particularly point out subject matter from the above disclosure that is regarded as novel and non-obvious.

What is claimed is:

1. An audio system arranged in a listening environment in a vehicle, wherein the vehicle comprises at least one first passenger seat or row of seats facing in a first direction, and at least one second passenger seat or row of seats facing in a second direction opposite the first direction, wherein the audio system comprises;
a first multi-beam loudspeaker array configured to generate at least a first main beam and a second main beam; and
a second multi-beam loudspeaker array configured to generate at least a third main beam and a fourth main beam, and wherein the audio system is configured to:
direct the first main beam towards the at least one second passenger seat or row of seats to provide first audio content to the at least one second passenger seat or row of seats,
direct the second main beam towards the at least one first passenger seat or row of seats to provide second audio content that is different from the first audio content to the at least one first passenger seat or row of seats,
direct the third main beam towards the at least one first passenger seat or row of seats to provide the first audio content to the at least one first passenger seat or row of seats, and
direct the fourth main beam towards the at least one second passenger seat or row of seats to provide the second audio content to the at least one second passenger seat or row of seats.

2. The audio system of claim 1, wherein each of the first multi-beam loudspeaker array and the second multi-beam loudspeaker array comprises at least two loudspeakers.

3. The audio system of claim 2, wherein
a plane defined by a radiating surface of one loudspeaker of the first multi-beam loudspeaker array is arranged at an angle of between 0° and 180° with respect to the planes defined by the radiating surfaces of other loudspeakers of the first multi-beam loudspeaker array,
a plane defined by a radiating surface of one loudspeaker of the second multi-beam loudspeaker array is arranged at an angle of between 0° and 180° with respect to the planes defined by the radiating surfaces of the other loudspeakers of the second multi-beam loudspeaker array,
the radiating surfaces of the at least two loudspeakers of the first multi-beam loudspeaker array have identical diameters, and a distance between two neighboring loudspeakers of the first multi-beam loudspeaker array is less than twice a diameter of a radiating surface, and
the radiating surfaces of the at least two loudspeakers of the second multi-beam loudspeaker array have identical diameters, and a distance between two neighboring loudspeakers of the second multi-beam loudspeaker array is less than twice the diameter of a radiating surface.

4. The audio system of claim 1, wherein
the first multi-beam loudspeaker array is arranged between the at least one first passenger seat or row of seats and the at least one second passenger seat or row of seats in a first horizontal direction, and towards a first side of the first passenger seat or row of seats and the at least one second passenger seat or row of seats in a second horizontal direction that is perpendicular to the first horizontal direction; and
the second multi-beam loudspeaker array is arranged between the at least one first passenger seat or row of seats and the at least one second passenger seat or row of seats in the first horizontal direction, and towards a second side of the first passenger seat or row of seats and the at least one second passenger seat or row of seats in the second horizontal direction.

5. The audio system of claim 1 further comprising an audio source configured to output an audio input having left audio content and right audio content.

6. The audio system of claim 5, wherein
the left audio content is a left channel, a left stereo audio signal, or a left audio content derived from a stereo source, and
the right audio content is a right channel, right stereo audio signal, or a right audio content derived from a stereo source.

7. The audio system of claim 6, wherein the first audio content is the left audio content of the audio input, and the second audio content is the right audio content of the audio input.

8. The audio system of claim 7 further comprising:
a first loudspeaker beamformer having two inputs, wherein, at a first input, the first loudspeaker beamformer receives the left audio content, and at a second input the first loudspeaker beamformer receives the right audio content, and wherein the first loudspeaker beamformer is further connected to the first multi-beam loudspeaker array, and each of the left channel and the right channel corresponds to a different one of the first main beam and the second main beam; and
a second loudspeaker beamformer having two inputs, wherein, at a first input, the second loudspeaker beamformer receives the left audio content, and at a second input the second loudspeaker beamformer receives the right audio content, and wherein the second loudspeaker beamformer is further connected to the second multi-beam loudspeaker array, and each of the left channel and the right channel corresponds to a different one of the third main beam and the fourth main beam.

9. The audio system of claim 8, wherein
the first loudspeaker beamformer comprises a plurality of first beamforming filters and a first rotation matrix for the left channel and a plurality of second beamforming filters and a second rotation matrix for the right channel, and
the second loudspeaker beamformer comprises a plurality of first beamforming filters and a first rotation matrix for the left channel and a plurality of second beamforming filters and a second rotation matrix for the right channel.

10. The audio system of claim 9, wherein
each loudspeaker of the first multi-beam loudspeaker array is connected to one or more of the plurality of first beamforming filters, and to one or more of the plurality of second beamforming filters of the first loudspeaker beamformer; and
each loudspeaker of the second multi-beam loudspeaker array is connected to one or more of the plurality of first beamforming filters, and to one or more of the plurality of second beamforming filters of the second loudspeaker beamformer.

11. The audio system of claim 9, wherein each of the first beamforming filters and the second beamforming filters
comprise a Finite Impulse Response, FIR, filter, or an Infinite Impulse Response, IIR, filter, or
implements gain and delay array techniques.

12. The audio system of claim 9, wherein
each of the first rotation matrix and the second rotation matrix of the first loudspeaker beamformer is an L x M gain matrix, wherein L is a number of first beamforming filters or the second beamforming filters connected to the respective first or second gain matrix, and M is the number of loudspeakers comprised in the first multi-beam loudspeaker array, and
each of the first rotation matrix and the second rotation matrix of the second loudspeaker beamformer is an L x M gain matrix, wherein L is the number of first beamforming filters or the second beamforming filters connected to the respective first or second gain matrix, and M is the number of loudspeakers comprised in the second multi-beam loudspeaker array.

13. The audio system of claim 1, wherein the vehicle is a passenger car, a van, a camper van, a caravan, a truck, a bus, a tractor, an airplane, or a ship.

14. The audio system of claim 1, wherein
passengers seated on the at least one first passenger seat or row of seats face towards a windshield of the vehicle, and passengers seated on the second passenger seat or row of seats face towards a rear window of the vehicle, and
the first multi-beam loudspeaker array is arranged in or mounted to a right-side panel of the vehicle, and the second multi-beam loudspeaker array is arranged in or mounted to a left side panel of the vehicle.

15. The audio system of claim 1, wherein
passengers seated on the at least on first passenger seat or row of seats face towards a right-side window of the vehicle, and passengers seated on the second passenger seat or row of seats face towards a left side window of the vehicle, and
the first multi-beam loudspeaker array is arranged in or mounted to a rear panel of the vehicle, and the second multi-beam loudspeaker array is arranged in or adjacent to a center console of the vehicle.

16. An audio system arranged in a listening environment in a vehicle, the audio system comprises;
a first multi-beam loudspeaker array configured to generate at least a first main beam and a second main beam; and
a second multi-beam loudspeaker array configured to generate at least a third main beam and a fourth main beam, and wherein the audio system is configured to:
direct the first main beam towards at least one first passenger seat or a row of seats to provide first audio content to the at least one first passenger seat or the row of seats,
direct the second main beam towards at least one second passenger seat or row of seats to provide second audio content that is different from the first audio content to the at least one second passenger seat or the row of seats,
direct the third main beam towards the at least one second passenger seat or the row of seats to provide the first audio content to the at least one second passenger seat or row of seats, and
direct the fourth main beam towards the at least one first passenger seat or to the row of seats to provide the second audio content to the at least one first passenger seat or the row of seats.

17. The audio system of claim 16, wherein
the first multi-beam loudspeaker array is arranged between the at least one first passenger seat or the row of seats and the at least one second passenger seat or the row of seats in a first horizontal direction, and towards a first side of the first passenger seat or the row of seats and the at least one second passenger seat or the row of seats in a second horizontal direction that is perpendicular to the first horizontal direction; and
the second multi-beam loudspeaker array is arranged between the at least one first passenger seat or row of seats and the at least one second passenger seat or row of seats in the first horizontal direction, and towards a second side of the first passenger seat or row of seats and the at least one second passenger seat or row of seats in the second horizontal direction.

18. The audio system of claim 16 further comprising an audio source configured to output an audio input having left audio content and right audio content.

19. The audio system of claim 18, wherein
the left audio content is a left channel, a left stereo audio signal, or a left audio content derived from a stereo source, and
the right audio content is a right channel, right stereo audio signal, or a right audio content derived from a stereo source.

20. An audio system arranged in a listening environment in a vehicle, the audio system comprises:
a first multi-beam loudspeaker array configured to generate at least a first main beam and a second main beam; and
a second multi-beam loudspeaker array configured to generate at least a third main beam and a fourth main beam, and wherein the audio system is configured to:
direct the first main beam towards at least one first passenger seat or a row of seats to provide first audio content to the at least one first passenger seat or the row of seats,
direct the second main beam towards at least one second passenger seat or row of seats to provide second audio content that is different from the first audio content to the at least one second passenger seat or the row of seats,
direct the third main beam towards the at least one second passenger seat or the row of seats to provide the first audio content to the at least one second passenger seat or row of seats, and
direct the fourth main beam towards the at least one first passenger seat or to the row of seats to provide the second audio content to the at least one first passenger seat or the row of seats,
wherein the at least one first passenger seat or row of seats faces a first direction, and the at least one second passenger seat or row of seats faces a second direction opposite the first direction.
